(19) United States
(12) Patent Application Publication
(10) Pub. No.: US 2009/0075163 A1
(43) Pub. Date: Mar. 19, 2009

(54) SYSTEM AND METHOD FOR ELECTRICALLY CONNECTING TERMINALS OF A BATTERY

(75) Inventors: Bryan Shevock, Virginia Beach, VA (US); Patrick Daniel Maguire, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/855,497

(22) Filed: Sep. 14, 2007

(51) Int. Cl. H01M 2/26

(52) U.S. Cl. 429/121; 429/123

(57) ABSTRACT

Terminals of a battery pack are electrically connected via bus bars. The terminals are configured to receive and retain a portion of a bus bar via a retention force. The terminals allow a bus bar to have more than one orientation relative to the terminal. Additionally, the terminals include features that locate the bus bars relative to the terminals.

### BACKGROUND

1. Field of the Invention

The invention relates to systems and methods for electrically connecting terminals of a battery.

2. Discussion

High voltage battery packs may include a plurality of battery modules electrically inter-connected. These electrical inter-connections may be permanently attached to the battery modules or removably attached to the battery modules via threaded fasteners with torque prevailing features.

### SUMMARY

Embodiments of the invention may take the form of a system for electrically connecting modules of a vehicle power storage unit. The system includes an electrical bus and a module having a terminal. The terminal is configured to receive and retain a portion of the electrical bus. The system also includes an additional module having an additional terminal. The additional terminal is configured to receive and retain another portion of the electrical bus.

Embodiments of the invention may take the form of a system for electrically connecting modules of a vehicle power storage unit. The system includes an electrical bus and a module having a terminal. The terminal is configured to receive and retain a portion of the electrical bus. The system also includes an additional module having an additional terminal. The electrical bus is configured to receive and retain a portion of the additional terminal.

Embodiments of the invention may take the form of a method for electrically connecting a first terminal of a first module with a second terminal of a second module of a vehicle power storage. The method includes inserting a portion of the electrical bus into the first terminal wherein the first terminal retains the portion of the electrical bus and inserting another portion of the electrical bus into the second terminal wherein the second terminal retains the another portion of the electrical bus.

### BRIEF DESCRIPTION OF THE DRAWINGS

FIG. 1 is an exploded assembly view of a portion of an example high voltage battery.

FIG. 2 is a perspective view of a module of the high voltage battery of FIG. 1.

FIG. 3A is a perspective view of a terminal of the module of FIG. 2.

FIG. 3B is a side view of the terminal of FIG. 3A.

FIG. 4 is top view of a blank used to manufacture the terminal of FIG. 3A.

FIG. 5 is a top view of a portion of an example battery.

FIG. 6 is a side view, in cross-section, of a terminal of FIG. 5.

FIGS. 7A-7B are top views of the terminal of FIG. 6.

FIGS. 8A-8D are perspective views of a high voltage bus bar of FIG. 5.

FIG. 9 is a side view of a portion of an example traction battery.

### DETAILED DESCRIPTION

Some embodiments of the invention provide a spring loaded clip made from a piece of stamped and folded sheet metal. The stamping profile may be rectangular with fins at one end. A retention barb may be cut into the piece and dimples may be created to allow for projection welding. The final piece may be projection welded onto an exposed surface of a battery module.

Other embodiments of the invention provide bus bars with oversized holes for retention barbs. A bus bar may be inserted into a terminal with a retention barb. The retention barb prevents the bus bar from moving out of the terminal.

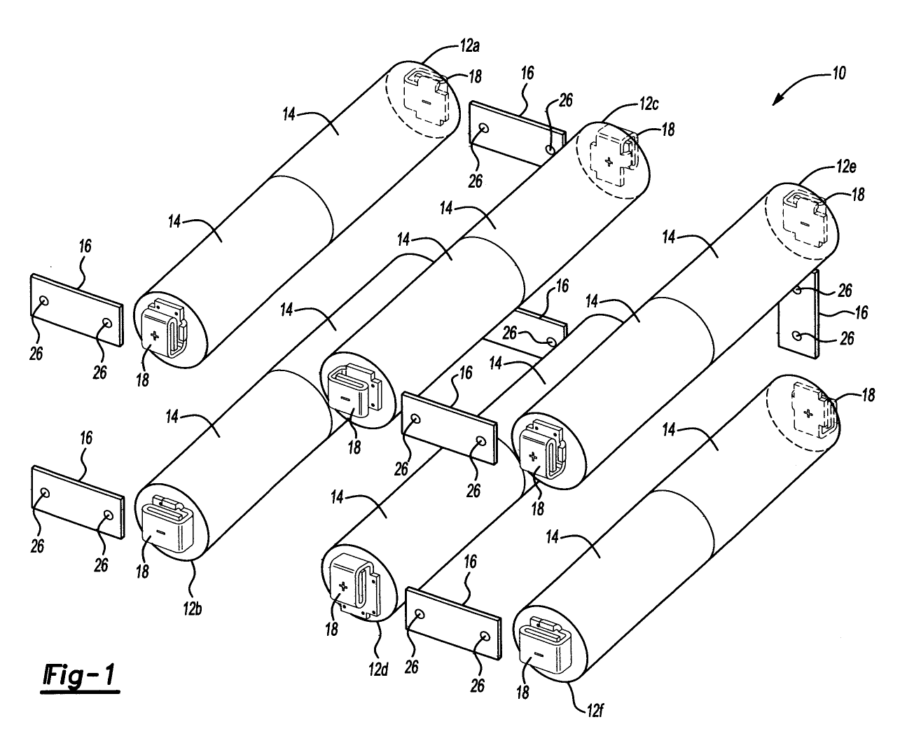

FIG. 1 is an exploded assembly view of a portion of high voltage battery 10. An array of battery modules 12a-12f is shown absent module housings. Battery modules 12a, 12b share a common housing (not shown), battery modules 12c, 12d share a common housing (not shown), and battery modules 12e, 12f share a common housing (not shown). Each of battery modules 12a-12f are in one of four orientations. Battery modules 12a, 12e are in a first orientation, battery modules 12b, 12f are in a second orientation, battery module 12c is in a third orientation, and battery module 12d is in a fourth orientation. In other embodiments, the battery modules may be configured differently, e.g., differing numbers of cells, etc.

Each of battery modules 12a-12f includes battery cells 14 electrically connected in series. As such, each of battery modules 12a-12f includes positive and negative poles. These positive and negative poles are electrically connected via bus bars 16. In the embodiment of FIG. 1, battery modules 12a, 12c, 12e are electrically linked via bus bars 16, e.g., bar stock, battery modules 12b, 12d, 12f are electrically linked via bus bars 16, and battery modules 12e, 12f are electrically linked via bus bar 16. In other embodiments, the battery modules may be electrically connected as desired, e.g., battery modules 12a, 12b may be electrically linked via bus bars 16, etc.

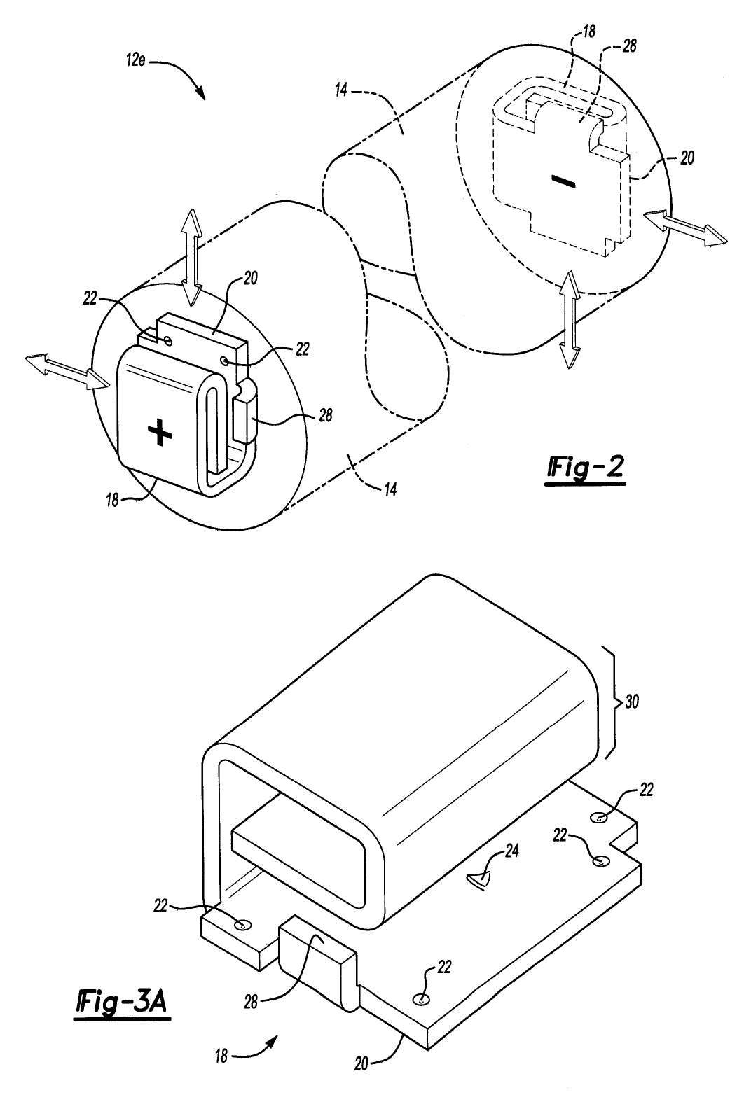

FIG. 2 is a perspective view of battery module 12e of FIG. 1. Battery module 12e includes clip bus bar terminals 18. Clip bus bar terminal 18 associated with the positive pole of battery module 12e has an orientation rotated 90 degrees from clip bus bar terminal 18 associated with the negative pole of battery module 12e. Clip bus bar terminals 18 allow bus bars 16 (FIG. 1) to be clipped, e.g., snapped, in one of two directions as shown by arrow.

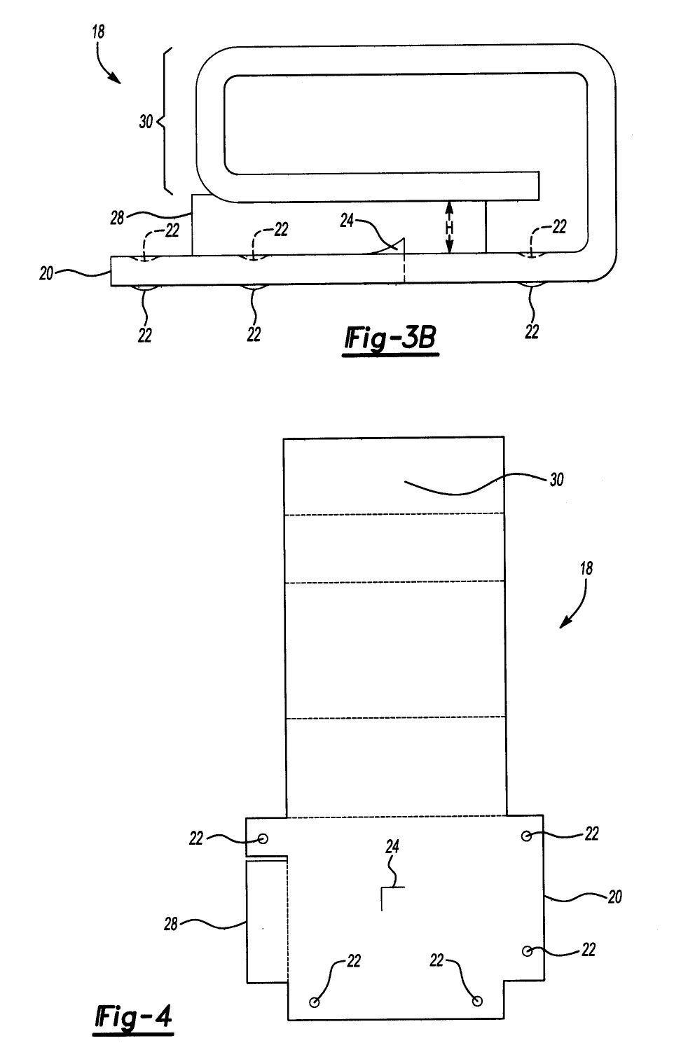

FIG. 3A is a perspective view of clip bus bar terminal 18 of FIG. 2. Bottom portion 20 is electrically connected with one of the positive or negative poles of battery module 12e. In the embodiment of FIG. 3A, bottom portion 20 is projection welded with battery module 12e at weld points 22. In alternative embodiments, bottom portion 20 may be seam welded or otherwise attached with battery module 12e. Bus bar retention device 24, e.g., projection, as explained below, is received by one of openings 26 of bus bar 16 (FIG. 1). Stop 28 limits the movement of bus bar 16 once clipped with clip bus bar terminal 18. As such, bus bar retention device 24 and/or stop 28 locate bus bar 16 relative to clip bus bar terminal 18.

FIG. 3B is a side view of clip bus bar terminal 18 of FIG. 3A. Compression portion 30 provides a compression force against bus bar 16 (FIG. 1) when bus bar 16 is clipped with clip bus bar terminal 18. For example, the height, H, of clip bus bar terminal 18 is less than the thickness of bus bar 16 such that there is an interference fit between compression portion 30 and bus bar 16.

FIG. 4 is a blank, e.g., sheet metal stamping, used to manufacture clip bus bar terminal 18 of FIG. 3A. Dashed lines indicate seams along which the blank is bent to form clip bus bar terminal 18. Additionally, bus bar retention device 24 is formed, for example, via a cut through.

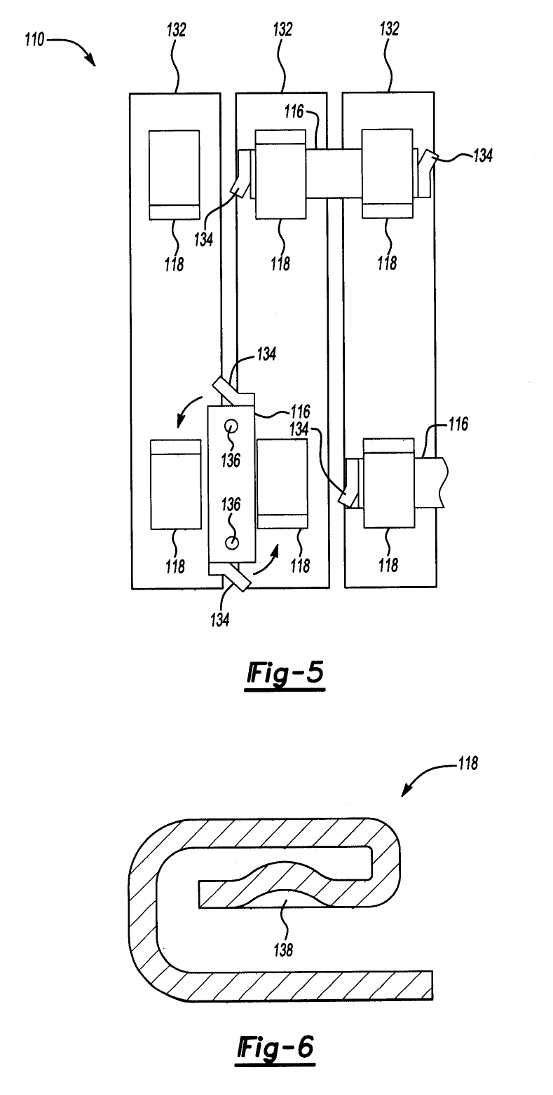

FIG. 5 is a top view of a portion of battery 110. Elements differing by 100 have similar, although not necessarily identical, descriptions, e.g., batteries 10, 110. Modules 132 each have a respective pair of terminals 118 electrically connected with battery cells (not shown) within modules 132.

Bus bars 116 electrically connect certain terminals 118 of modules 132 by twisting them into place as indicated by arrow. Guide features 134 assist in guiding bus bars 116 into place relative to terminals 118. Dimples 136 further assist in guiding bus bars 116 into place by, for example, mating with recessed portion 138 (FIG. 6) of terminal 118. As discussed above, terminals 118 provide a spring force which holds bus bars 116 in place.

FIG. 6 is a side view, in cross-section, of terminal 118 of FIG. 5. Recessed portion 138 may be formed, for example, by a punching operation.

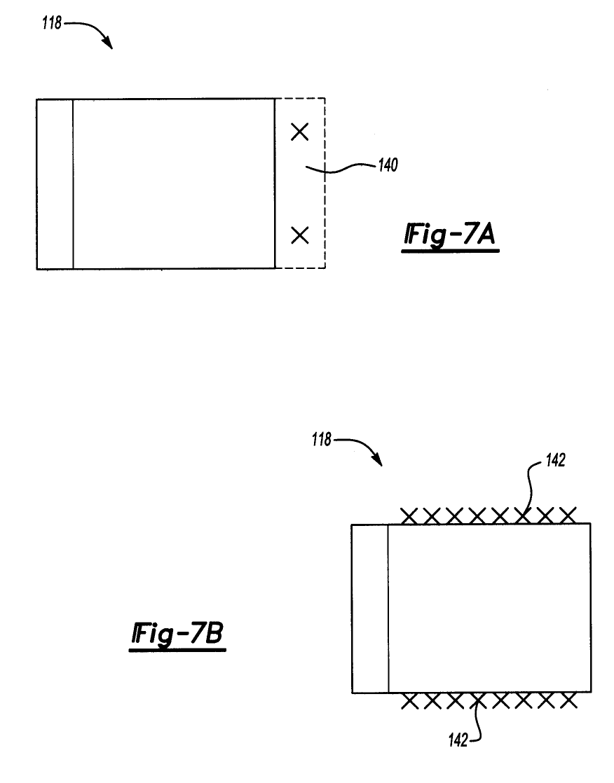

FIGS. 7A-7B are top views of terminal 118 of FIG. 6. FIG. 7A shows that terminal 118 may be projection welded with modules 132 (FIG. 5) at section 140. FIG. 7B shows that terminal 118 may be seam welded with modules 132 at sections 142. In alternative embodiments, terminal 118 may be attached to modules 132 as desired, e.g., adhered, etc.

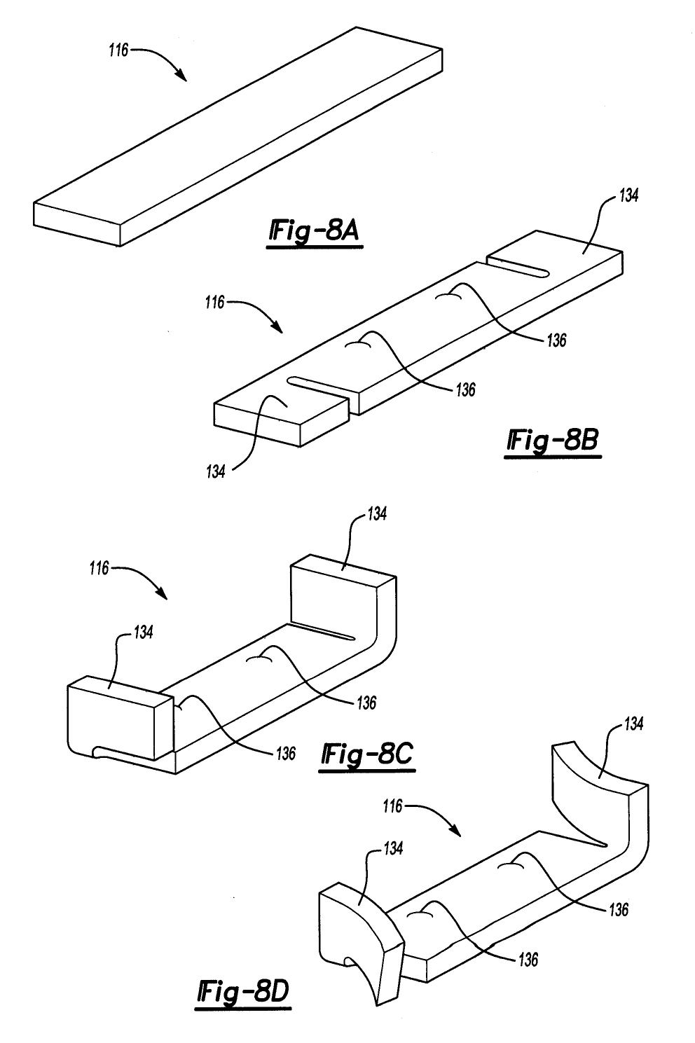

FIGS. 8A-8D are perspective views of bus bar 116 at various stages of manufacture. FIG. 8A shows bus bar 116 as a rectangular bar stock. FIG. 8B shows bus bar 116 with guide features 134 and dimples 136 after cutting and punching operations. FIG. 8C shows bus bar 116 after a bending operation. FIG. 8D shows bus bar 116 after a flaring operation.

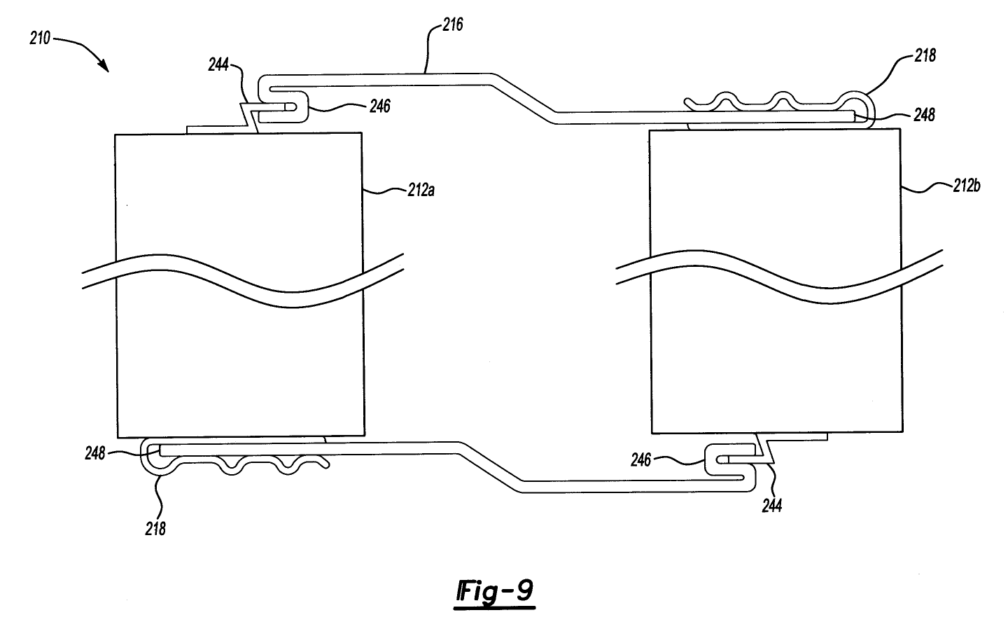

FIG. 9 is a side view of a portion of traction battery 210. Terminal 244 is electrically connected with battery module 212a. Terminal 218 is electrically connected with battery module 212b. High voltage bus bar 216 electrically connects battery modules 212a, 212b. High voltage bus bar 216 includes female end 246, which clips to terminal 244 via, for example, a compression force as described above. Terminal 218 clips to male end 248 of high voltage bus bar 216 via, for example, a spring force as described above.

As discussed above, terminal 218 allows bus bar 216 to be clipped in more than one direction relative to battery module 212b. Similarly, bus bar 216 allows terminal 244 to be clipped in more than one direction relative to battery module 212a.

The above battery configurations may offer several advantages including a reduced part count, a reduced weight, a reduced volume, joints that are less prone to torque loss, and increased ease of assembly and/or disassembly.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A system for electrically connecting modules of a vehicle power storage unit, the system comprising:
an electrical bus;
a module having a terminal and an electrochemical cell wherein the terminal is electrically connected with the electrochemical cell and wherein the terminal is configured to receive and retain a portion of the electrical bus; and
an additional module having an additional terminal and an additional electrochemical cell wherein the additional terminal is electrically connected with the additional electrochemical cell and wherein the additional terminal is configured to receive and retain another portion of the electrical bus.

2. The system of claim 1 wherein the terminal retains the portion of the electrical bus via a retention force.

3. The system of claim 1 wherein the terminal includes a female portion configured to receive the electrical bus.

4. The system of claim 3 wherein the electrical bus includes a male portion configured to be received by the female portion of the terminal.

5. The system of claim 1 wherein the terminal is further configured to permit the electrical bus to be retained in at least one of first and second positions relative to the module.

6. The system of claim 1 wherein the terminal includes a feature configured to reduce movement of the electrical bus relative to the terminal.

7. The system of claim 6 wherein the feature comprises a guide to locate the electrical bus relative to the terminal.

8. The system of claim 1 wherein the electrical bus comprises a conductive bar.

9. The system of claim 1 wherein the electrical bus comprises a conductive cable.

10. A system for electrically connecting modules of a vehicle power storage unit, the system comprising:
an electrical bus;
a module having a terminal and an electrochemical cell wherein the terminal is electrically connected with the electrochemical cell and wherein the terminal is configured to receive and retain a portion of the electrical bus; and
an additional module having an additional terminal and an additional electrochemical cell wherein the additional terminal is electrically connected with the additional electrochemical cell and wherein the electrical bus is configured to receive and retain a portion of the additional terminal.

11. The system of claim 10 wherein the terminal retains the portion of the electrical bus via a retention force.

12. The system of claim 10 wherein the electrical bus retains the portion of the additional terminal via a retention force.

13. The system of claim 10 wherein the terminal includes a female portion configured to receive the portion of the electrical bus.

14. The system of claim 10 wherein the electrical bus includes a female portion configured to receive the portion of the additional terminal.

15. The system of claim 10 wherein the terminal is further configured to permit the electrical bus to be retained in at least one of first and second positions relative to the module.

16. The system of claim 10 wherein the terminal includes a feature configured to reduce movement of the electrical bus relative to the terminal.

17. The system of claim 16 wherein the feature comprises a guide to locate the electrical bus relative to the terminal.

18. A method for electrically connecting a first terminal of a first module with a second terminal of a second module of a vehicle power storage unit via an electrical bus, the method comprising:
inserting a portion of the electrical bus into the first terminal wherein the first terminal retains the portion of the electrical bus; and
inserting another portion of the electrical bus into the second terminal wherein the second terminal retains the another portion of the electrical bus.

19. The method of claim 18 wherein the first terminal retains the portion of the electrical bus via a retention force.

20. The method of claim 18 wherein the second terminal retains the another portion of the electrical bus via a retention force.
